(19) United States
(12) Patent Application Publication
(10) Pub. No.: US 2023/0277406 A1
(43) Pub. Date: Sep. 7, 2023

(54) MASSAGE DEVICE TO CONTROL THE MASSAGE MODULE

(71) Applicant: BODYFRIEND CO., LTD., Seoul (KR)

(72) Inventors: Woong Chul KANG, Seoul (KR); Deok Hyun KONG, Seoul (KR); Han Il KIM, Seoul (KR)

(21) Appl. No.: 18/118,523

(22) Filed: Mar. 7, 2023

(30) Foreign Application Priority Data
Mar. 7, 2022 (KR) 10-2022-0028551
Mar. 21, 2022 (KR) 10-2022-0034453

(51) Int. Cl. A61H 7/00

(52) U.S. Cl. CPC A61H 7/004; A61H 2201/0149; A61H 2201/5005; A61H 2201/5058

(57) ABSTRACT

A massage device for controlling a massage module includes a main frame for supporting body of a user, a massage module for providing a massage to at least a part of the body while moving along the main frame, and a control unit for controlling the massage module, wherein the control unit determines at least one of a standby position, at which the massage module is on standby in the main frame of the massage device, based on whether a massage mode of the massage device has ended, and a standby intensity, which is an intensity at which the massage module presses the body at the standby position, and the control unit controls operation of the massage module based on at least one of the standby position and the standby intensity.

### CROSS-REFERENCE TO RELATED APPLICATION

The present application claims priority to Korean Patent Application No. 10-2022-0028551, filed on Mar. 7, 2022, and Korean Patent Application No. 10-2022-0034453, filed on Mar. 21, 2022, the entire disclosures of which are incorporated herein by references.

### TECHNICAL FIELD

The present disclosure relates to a massage device, and more particularly, to a massage device for controlling a massage module according to preference standby information set by a user when a massage mode ends.

### BACKGROUND ART

Massage is a medical adjuvant therapy that regulates modulation of the body of a subject, assists in blood circulation, and relieves fatigue of the subject by applying various types of mechanical stimulation to a part of the body, such as kneading, pressing, pulling, tapping, or moving a part of the body of the subject.

For economic and time reasons, an increase in massage demand has led to an increase in demand for a massage device or massage apparatus for providing an artificial massage function. That is, with an increase in demand to relieve fatigue or stress by relaxing tightened muscles through a massage, various time- and cost-effective massage devices have been released. Any types of equipment, devices, or apparatuses that perform a massage through mechanical devices without a separate masseur are referred to as massage devices.

Furthermore, there is an increase in users' demand for a massage device capable of improving health as well as relieving fatigue or stress through massaging.

Therefore, research is continuously conducted to provide a massage device that may improve users' health.

### DISCLOSURE

### Technical Problem

The present disclosure has been derived to solve the above-mentioned problems occurring in the related art, and it is an object of the present invention to control a massage module according to preference standby information set by a user when a massage mode ends.

### Technical Solution

In order to achieve the object described above, according to one embodiment of the present disclosure, a massage device includes a main frame for supporting the body of a user, a massage module for providing a massage to at least a part of the body while moving along the main frame, and a control unit for controlling the massage module, wherein the control unit may determine at least one of a standby position, at which the massage module is on standby in the main frame of the massage device, based on whether a massage mode of the massage device has ended, and a standby intensity, which is an intensity at which the massage module presses the body at the standby position, and the control unit may control the operation of the massage module based on at least one of the standby position and the standby intensity.

### Advantageous Effects

According to one embodiment of the present disclosure, the massage device has an effect of improving user's satisfaction with using the massage device by improving the seating comfort of a user who is seated in the massage device and the sleep satisfaction of a user who sleeps in the massage device.

Effects which may be obtained through the present disclosure are not limited the above-described effect, and other effects, which are not described above, will be clearly understood through the following description by those of ordinary skill in the art to which the present disclosure belongs.

### DESCRIPTION

### Description of Drawings

FIG. 1 is a view for describing a massage device according to one embodiment of the present disclosure.

FIG. 2 is a view for describing a main frame according to one embodiment of the present disclosure.

FIG. 3 is a view for describing a detailed configuration of a massage device according to one embodiment of the present disclosure.

FIG. 4 is a view showing an external device capable of communicating with a massage device 1000 according to one embodiment of the present disclosure.

FIG. 5 shows an example for describing a control operation of a control unit according to one embodiment of the present disclosure.

FIG. 6 is a view for describing the step of setting preference standby information shown in FIG. 5.

FIG. 7 is a view for describing the step of determining a standby position and a standby intensity shown in FIG. 5.

FIG. 8 is a view for describing the step of controlling a massage module shown in FIG. 5.

FIG. 9 is a view for describing the step of maintaining the operation of the massage module and the stopped massage device shown in FIG. 8.

FIG. 10 shows another example for describing a control operation of a control unit according to one embodiment of the present disclosure.

FIG. 11 is a view for describing a step of re-controlling the operation of the massage module and the stopped massage device shown in FIG. 10.

FIG. 12 is a view for describing a preference position and a preference intensity according to one embodiment of the present disclosure.

### BEST MODE OF THE INVENTION

The advantages and features of the disclosed embodiments and methods for accomplishing the same will be more clearly understood from embodiments to be described below with reference to the accompanying drawings. However, the present disclosure is not limited to the following embodiments but may be implemented in various different forms. The embodiments are provided only to complete the present disclosure and to fully provide the scope of the present disclosure to those of ordinary skill in the art to which the present disclosure belongs.

Terms used in the present specification will be briefly described, and then the disclosed embodiments will be described in detail.

The terms used in the present specification have been selected from general terms widely used in the art in consideration functions of the present disclosure, and the terms may be changed depending on the intention or convention of those of ordinary in the art or the introduction of new technology. Also, in specific cases, terms may be arbitrarily defined by an applicant, in which case their meaning will be described in detail in the detailed description of the present disclosure. Therefore, the terms used in the present specification should be construed based on the overall content of the present disclosure together with the actual meanings of the terms rather than their simple names or meanings.

In the present specification, a singular expression may include a plural expression unless otherwise stated in context. In addition, a plural expression may include a singular expression unless otherwise stated in context.

Throughout the specification of the present disclosure, when it is said that a certain part “includes” a certain component, it means that it may further include other components, not excluding other components unless otherwise stated. In addition, the term “unit” used in the present disclosure includes software components or hardware components to perform certain tasks. However, the term “unit” is not limited to software or hardware. A “unit” may be configured to reside in an addressable storage medium and configured to operate one or more processors. Thus, a “unit” may include, by way of example, components such as software components, object-oriented software components, class components and task components, processes, functions, attributes, procedures, sub-routines, segments of program code, drivers, firmware, microcode, circuitry, data, databases, data structures, tables, arrays, and parameters. The functionality provided in the components and “units” may be combined into fewer components and “units” or further separated into additional components and “units”.

According to one embodiment of the present disclosure, a “unit” may be implemented as a processor and a memory. The term “processor” should be interpreted broadly to include a general-purpose processor, a central processing unit CPU, a microprocessor, a digital signal processor DSP, a control unit, a micro-control unit, a state machine, and the like. In some environments, a “processor” may be an application specific integrated circuit ASIC, a programmable logic device PLD, a field programmable gate array FPGA, and the like. The term “processor” may also be a combination of processing devices, for example, a combination of a DSP and a microprocessor, a combination of a plurality of microprocessors, a combination of one or more microprocessors connected to a DSP core, or a combination of other arbitrary constituent elements.

The term “memory” should be interpreted broadly to include any electronic component capable of storing electronic information. The term “memory” may be various types of processor-readable media such as a random access memory RAM, a read-only memory ROM, a non-volatile random access memory NVRAM, a programmable read-only memory PROM, an erasable programmable read-only memory EPROM, an electrically erasable PROM EEPROM, a flash memory, a magnetic or optical data storage, registers, and the like. When the processor may read information from a memory and/or may write information in the memory, the memory is referred to as being in an electronic communication state with a processor. The memory integrated into the processor is in an electronic communication state with the processor.

In the present specification, an actuator is a component capable of providing a driving force. For example, the actuator may include a motor, a linear motor, an electronic motor, a direct current DC motor, an alternating current AC motor, a linear actuator, an electric actuator, and the like, but not limited thereto.

Herein, according to one embodiment, a massage device may refer to a massage device including at least one of a body massage unit, an arm massage unit, and a leg massage unit. In addition, according to another embodiment, a body massage unit, an arm massage unit and a leg massage unit may be provided as separate devices, for example, a body massage device, an arm massage device and a leg massage device, and the massage device may refer to at least one of the body massage device, the arm massage device, and the leg massage device.

Hereinafter, embodiments will be described in detail with reference to the accompanying drawings so that those of ordinary in the art to which the present disclosure belongs may easily practice the disclosure. In order to clearly describe the present disclosure, parts irrelevant to the description are omitted in the drawings.

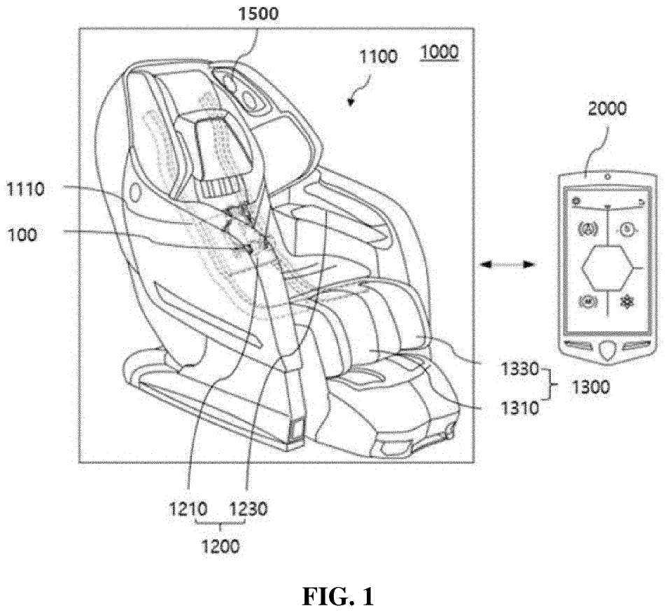

FIG. 1 is a view showing a massage device according to one embodiment of the present disclosure.

According to one embodiment of the present disclosure, a massage device 1000 may have an area for accommodating at least a part of the body of a user, support the body of the user, and include at least one massage unit among a body massage unit 1100 for massaging at least a part of the body of the user, an arm massage unit 1200 for massaging an arm of the user and a leg massage unit 1300 for massaging a leg of the user.

The arm massage unit 1200 may be disposed on one side and/or the other side of the body massage unit 1100. For example, the arm massage unit 1200 may include a first arm massage unit 1210 that is disposed on one side (or left side) of the body massage unit 1100 so as to massage one side arm of the user and/or a second arm massage unit 1230 that is disposed on the other side (or right side) of the body massage unit 1100 so as to massage the other side arm of the user. The first and second arm massage units 1210, 1230 may operate independently of each other based on the control of the control unit that controls the massage device 1000.

The leg massage unit 1300 may be disposed at the lower portion of the body massage unit 1100 and/or at the front lower portion of the massage device 1000. The leg massage unit 1300 may include a first leg massage unit 1310 that is disposed at one side of the leg massage unit 1300 so as to massage one side leg of the user and/or a second leg massage unit 1330 that is disposed at the other side of the leg massage unit 1300 so as to massage the other side leg of the user.

The body massage unit 1100 may provide massage to at least a part of the body of the user. For example, the body massage unit 1100 may massage at least a part of at least one of the upper body and the lower body of the user.

The body massage unit 1100 may include a massage module 100 for providing a massage function to at least a part of the body of the user, an audio output module 1500 for providing an arbitrary type of audio output to the user, a main frame 1110, which constitutes a framework of the body massage unit 1100 and supports the body of the user, and a user input unit for receiving an arbitrary type of input from the user (not shown).

The above-described constituent elements that the body massage unit 1100 includes are merely an exemplary embodiment, and the body massage unit 1100 may include a variety of components in addition to the above-described constituent elements.

In addition, the shape and structure of the massage device 1000 as shown in FIG. 1 are exemplary only, and various types of massage device 1000 may also be included within the scope of the present disclosure without departing from the scope of the present disclosure which is defined by the claims.

The body massage unit 1100 may form a space having an arbitrary shape for accommodating the user. The body massage unit 1100 may include a space having a shape corresponding to a shape of the body of the user. For example, as shown in FIG. 1, the body massage unit 1100 may be implemented as a sitting type capable of accommodating a part or whole part of the body of the user.

A part of the body massage unit 1100 which comes into contact with the ground may include an arbitrary material for increasing a frictional force or an arbitrary member (for example, a skid-proof pad and the like) for increasing a frictional force and may include wheels for reinforcing mobility of the massage device 1000.

At least a part of the body massage unit 1100 may slidingly move. For example, when the body massage unit 1100 starts massage, at least a part of the body massage unit 1100 slidingly moves forward. In addition, the body massage unit 1100 may be tilted backward. As a result, the body massage unit 1100 may provide a massage in a backward tilted state. For example, the massage device 1000 may include an actuator for enabling the massage device 1000 (or the body massage unit 1100 to be tilted in the backward direction of the massage device 1000 (or the body massage unit 1100. The massage device 1000 may tilt the body massage unit 1100 or restore the body massage unit 1100 to an original state thereof by driving the above-described actuator. At this time, the actuator may be disposed on at least a part (for example, a base frame) of the massage device.

According to one embodiment of the present disclosure, the massage device 1000 may include at least one air cell (not shown). The air cell may be positioned on at least one of at least a partial area of the body massage unit 1100, at least a partial area of the arm massage unit 1200 and at least a partial area of the leg massage unit 1300. However, the position where the air cell is disposed is not limited thereto, and the air cell may be disposed on a variety of parts of the massage device 1000.

The massage device 1000 may include an air supply part, and the air supply part may supply air to the air cell so as to inflate the air cell. The air supply part may be positioned inside the body massage unit 1100 and may be positioned in the leg massage unit 1300. Furthermore, the air supply part may be positioned outside the massage device 1000.

The leg massage unit 1300 may include accommodation spaces for accommodating the legs of the user and provide the user a leg massage by massaging at least parts of the legs of the user. For example, the leg massage unit 1300 may include a calf massage unit for massaging the calves of the user and/or a foot massage unit for massaging the feet of the user.

The leg massage unit 1300 may be adjusted in length according to physical features of the user. For example, when a tall user uses the massage device 1000, the leg massage unit 1300 needs to be lengthened because the user's calves are long. Also, when a short user uses the massage device 1000, the leg massage unit 1300 needs to be shortened because the user's calves are short. Accordingly, the leg massage unit 1300 may provide a user-customized leg massage according to the height of the user.

The massage module 100 may be provided inside the body massage unit 1100 so as to provide the user accommodated in the body massage unit 1100 with a dynamic stimulus in an arbitrary form. As shown in FIG. 1, the massage module 100 may move along the main frame 1110 provided inside the body massage unit 1100. In other words, the massage module 100 may massage at least a part of the body of the user (or provide a massage to at least a part of the body of the user) while moving along the main frame 1110.

The main frame 1110 of the body massage unit 1100 may include a rack gear, and the massage module 100 may provide dynamic stimuli to a variety of parts of the body of the user while moving along the rack gear. For example, the massage module 100 may massage the body of the user by tapping or kneading at least one of the back, shoulders, waist, buttocks, and thighs of the user. The massage module 100 may include at least one of a ball massage unit and a roller massage unit, but is not limited thereto.

The main frame 1100 forms a framework of an interior structure of the body massage unit 1100 and may be implemented using a metal material, a plastic material, or the like. For example, the main frame 1100 may be implemented using iron, an alloy, steel, or the like but is not limited thereto and may be implemented using a variety of hard materials.

According to one embodiment of the present disclosure, the massage device 1000 may include an audio output module 1500. The audio output module 1500 may be provided in a variety of positions. For example, the audio output module 1500 may include a plurality of output units, such as an upper audio output unit disposed in an upper portion of a seat part which comes into contact with the user, forward audio output units attached to front portions of left and right arm massage units of the seat part, and/or rear audio output units attached to rear portions of the arm massage units, but is not limited thereto. In this case, the audio output module 1500 may provide stereophonic sound, such as 5.1 channel surround sound, but is not limited thereto.

According to one embodiment of the present disclosure, the user may control the massage device 1000 by using a massage device control device 2000. The massage device control device 2000 may be connected to the massage device 1000 through wired and/or wireless communications.

The massage device control device 2000 may include at least one personal device such as a remote control unit, a cellular phone and a personal digital assistant PDA, but is not limited thereto. In addition, the massage device control device 2000 may include a variety of electronic devices capable of being connected to the massage device 1000 through wired or wireless communications.

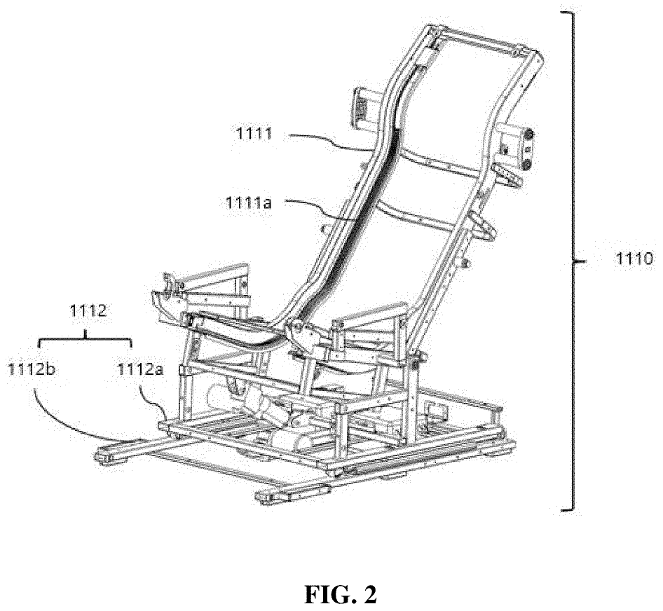

FIG. 2 is a view for describing a massage device according to one embodiment of the present disclosure.

According to one embodiment of the present disclosure, the main frame 1110 may include an upper frame 1111 on which the massage module 100 is provided and a base frame 1110 for supporting the upper frame 1111.

A rack gear 1151 may be provided on at least a part of the upper frame 1111. The rack gear 1111a is a member for guiding vertical movement of the body massage module 100 and may include a plurality of valley portions and a plurality of ridge portions.

According to one embodiment of the present disclosure, the rack gears 1111a may be provided on both sides of the upper frame 1111 so as to face each other, and the massage module 100 may move along the rack gears 1111a.

In FIG. 2, the rack gear 1111a is formed in the vertical direction, but the present disclosure is not limited thereto. The rack gear 1111a may include a rack gear in a front-rear direction and a rack gear in the vertical direction. In the present disclosure, the front-rear direction may be a direction from the massage module 100 toward the user or a direction from the user toward the massage module 100 and may also be referred to as a Z-axis direction.

The massage module 100 may include gears engaged with the rack gear 1111a. More specifically, the massage module 100 may include gears respectively engaged with the rack gear in the front-rear direction and the rack gear in the vertical direction. As the gear is rotated by an actuator provided in the massage module 100, the massage module 100 may move forward, backward, upward, or downward.

As the massage module 100 moves forward, an intensity of a massage may increase. In addition, as the massage module 100 moves backward, an intensity of a massage may decrease.

The rack gear 1111a may be implemented using a metal material or a plastic material. For example, the rack gear 1111a may be implemented using iron, steel, an alloy, reinforced plastic, a melamine resin, a phenol resin, or the like, but the present disclosure is not limited thereto.

The upper frame 1111 may be implemented in various shapes. For example, the upper frame 1111 may be classified into an S frame, an L frame, an S&L frame, and a double S&L frame in shape, but the present disclosure not limited thereto.

The S frame indicates a frame in which at least a part of the upper frame 1111 includes a curved shape like “S”, the L frame indicates a frame in which at least a part of the upper frame 1111 includes a curved shape like “L”, the S&L frame indicates a frame that includes both a part having a curved shape like “S” and a part having a curved shape like “L”, and the double S&L indicates a frame that includes a part having a curved shape like “L” and two parts having a curved shape like “S”.

The base frame 1112 supports the upper frame 1111 of the main frame 1110 and is a section that is in contact with a ground surface. The base frame 1112 may include a base upper frame 1112a and a base lower frame 1112b.

The base upper frame 1112a may support the upper frame 1111, and the base lower frame 1112b may be in contact with a ground surface. In addition, the base upper frame 1112a may be positioned in contact with the base lower frame 212.

According to one embodiment of the present disclosure, the base upper frame 1112a may move along the base lower frame 1112b. For example, the base upper frame 1112a may slidingly move forward or backward along the base lower frame 1112b. In this case, the upper frame 1111 may be connected to the base upper frame 1112a so as to move according to the movement of the base upper frame 1112a.

For example, when the base upper frame 1112a moves forward, the upper frame 1111 may also move forward along with the base upper frame 1112a, and when the base upper frame 1112a moves backward, the upper frame 1111 may also move backward along with the base upper frame 1112a. Thus, the body massage unit 1100 may be allowed to slidingly move.

Specifically, in order to allow movement of the base upper frame 1112a, a moving wheel may be provided on a lower portion of the base upper frame 1112a. In addition, a guide member capable of guiding the moving wheel may be provided on an upper portion of the base lower frame 1112b. The moving wheel provided on the base upper frame 1112a may move along the guide member provided on the base lower frame 1112b so as to allow the base upper frame 1112a to move forward or backward.

According to another embodiment of the present disclosure, the massage device 1000 may not be provided with a sliding function, in which case, the base frame 1112 may not be separated into the upper frame and the lower frame.

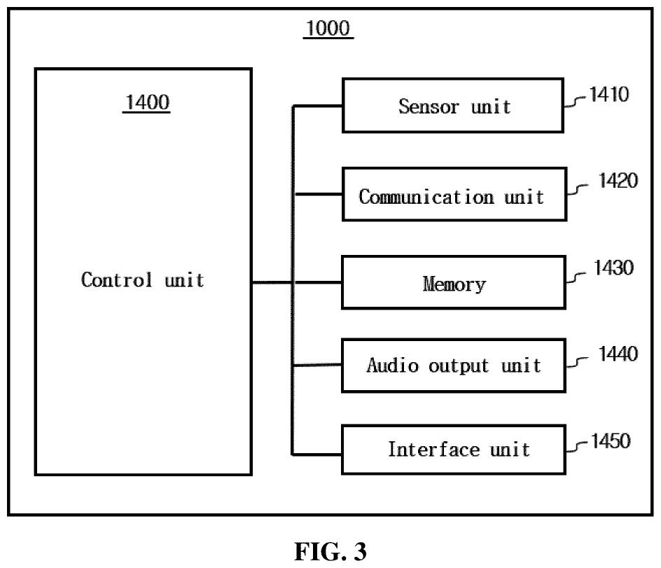

FIG. 3 is a view for describing a detailed configuration of a massage device according to one embodiment of the present disclosure.

According to one embodiment of the present disclosure, the massage device 1000 may include at least one of a control unit 1400, a sensor unit 1410, a communication unit 1420, a memory 1430, an audio output unit 1440, and an interface unit 1450. The control unit 1400 may include at least one processor and a memory. The at least one processor may execute commands stored in the memory.

The control unit 1400 may control the massage device 1000. For example, the control unit 1400 may control various detailed components of the massage device 1000, such as at least one of the body massage unit 1100, the arm massage unit 1200, the leg massage unit 1300, the sensor unit 1410, the communication unit 1420, the memory 1430, the audio output unit 1440, the interface unit 1450, and the output units.

The control unit 1400 may include one processor or may include a plurality of processors. When the control unit 1400 includes a plurality of processors, at least some of the plurality of processors may be positioned apart from each other physically. In addition, the massage device 1000 is not limited thereto and may be implemented in various ways.

According to one embodiment of the present disclosure, the control unit 1400 may control the operation of the massage device 1000. For example, the massage device 1000 may include a plurality of actuators, and the massage device 1000 may control the operation of the massage device 1000 by controlling the operation of the plurality of actuators.

For example, the massage device 1000 may include at least one of a driving unit for moving an armrest frame support part, at least one actuator included in a massage module 2170, a back angle actuator, a leg angle actuator, a foot massage actuator, a leg length adjustment actuator, and a sliding actuator. The processor 110 may control the operation of the massage device 1000 by controlling the actuators.

The back angle actuator is an actuator for adjusting an angle of a portion of the massage device 1000 with which the back of a user comes into contact, wherein a back angle of the massage device 1000 may be adjusted by the operation of the back angle actuator. The leg angle actuator is an actuator for adjusting an angle of a leg massage unit 1300 of the massage device 1000, and an angle between the leg massage unit 1300 and a body massage unit 1100 may be adjusted by the operation of the leg angle actuator. The foot massage actuator is an actuator for operating a foot massage module included in the leg massage unit 1300. The massage device 1000 may provide a foot massage to a user by using the foot massage actuator. The leg length adjustment actuator indicates an actuator for adjusting a length of the leg massage unit 1300. For example, by using the leg length adjusting actuator, the control unit 1400 may adjust the length of the leg massage unit 1300 to suit a user, and as a result, the user may receive a massage suitable for the user's body type.

At least one of the actuators included in the massage module 100 may be a variety of actuators such as a movement actuator, a forward and backward actuator, and a massage actuator.

The movement actuator is an actuator that enables the vertical movement of the massage module 100 so that the massage module 100 may move in the upward and/or downward direction of the massage device 1000 along a main frame 110. The massage module 100 may move along the rack gear by the operation of the massage module 100 movement actuator. The forward and backward actuator may move (or tilt) the massage module 100 in the forward and/or backward direction of the massage module 100. In other words, the massage module 100 may tilt in the forward and/or backward direction of the massage module 100 through the forward and backward actuator. The massage actuator may move the massage module 100 in various ways so as to provide various massage actions to the user.

The control unit 1400 may control the operation of the massage device 1000 by controlling various detailed components of the massage device 1000.

The control unit 1400 may provide various massage operations by operating at least one of the actuators provided in the massage device 1000. For example, the control unit 1400 may provide a tapping massage, a kneading massage, etc. by operating at least one of the actuators provided in the massage module 100. However, the present disclosure is not limited thereto and may provide various massage operations.

The memory 1430 may be provided in the control unit 1400 or outside the control unit. The memory 1430 may store various types of information related to the massage device 1000. For example, the memory 1430 may include massage control information and may include personal information of a user, but the present disclosure is not limited thereto. The personal information of a user may include various information related to the user, such as personal authentication information and biometric information of the user (for example, age, height, weight, blood pressure, body composition, heart rate, electrocardiogram, etc.).

The memory 1430 may be implemented through a non-volatile storage medium capable of continuously storing any data. For example, the memory 1430 may include a disk, an optical disc, and a magneto-optical storage device as well as a storage device based on a flash memory and/or a battery-backup memory, but the present disclosure is not limited thereto.

The memory 1430 may indicate a main storage device directly accessed by a processor, and may include a volatile storage device in which information stored therein is instantaneously erased when power is turned off, such as a random access memory RAM such as a dynamic random access memory DRAM and a static random access memory SRAM, but the present disclosure is not limited thereto. Such a memory 1430 may be operated by the control unit 1400.

The massage device 1000 may include the sensor unit 1410. The sensor unit 1410 may acquire various pieces of information by using at least one sensor. The sensor unit 1410 may be a sensor using a pressure, potential, or optical measuring means or the like. For example, the sensor unit may include a pressure sensor, an infrared sensor, a light-emitting diode LED sensor, a touch sensor, an electrode sensor, an air pressure measurement sensor or the like, but the present disclosure is not limited thereto.

Further, the sensor unit 1410 may include a biometric information acquisition sensor. The biometric information acquisition sensor may acquire fingerprint information, face information, voice information, iris information, weight information, blood pressure information, heart rate information, electrocardiogram information, body composition information, and the like, but the present disclosure is not limited thereto. For example, the massage device 1000 may provide a customized massage based on information acquired through the sensors.

The massage device 1000 may detect a contact area and/or a contact position with the user through sensors. In addition, the massage device 1000 may provide a customized massage based on the information acquired through the sensors.

The communication unit 1420 may receive a signal transmitted from an external device or transmit a signal with respect to the massage device 1000 to the external device.

For example, the control unit 1400 may obtain a result signal by processing the signal received through the communication unit 1420 and transmit the result signal to the communication unit 1420. The communication unit 1420 may transmit (output) the result signal to the external device.

The control unit 1400 may obtain information on the various components provided in the massage device 1000 (for example, information on the massage module 100, information on the arm massage unit 1200, or the like), and transmit the obtained information to the communication unit 1420. The communication unit 1420 may transmit the information on the massage device 1000 to the external device.

The communication unit 1420 may communicate with a module inside the massage device 1000, an external massage device, and/or a user terminal 2200 through any type of network. The communication unit may include a wired/wireless connection module for network connection. As a wireless connection technology, for example, wireless local area network WLAN, Wi-Fi, wireless broadband WiBro, world interoperability for microwave access WiMAX, high speed downlink packet access HSDPA, or the like may be used. As a wired connection technology, for example, x-digital subscriber line xDSL, fibers to the home FTTH, power line communication PLC, or the like may be used. In addition, a network connection unit may include a short-range communication module so as to transmit or receive data to or from any device/terminal positioned at a short distance. For example, as a short range communication technology, Bluetooth, radio frequency identification RFID, infrared data association IrDA, ultra-wideband UWB, ZigBee, or the like may be used, but the present disclosure is not limited thereto.

In addition, the massage device 1000 may further include the interface unit 1450.

The interface unit 1450 may be disposed on at least a part of the massage device 1000. For example, the interface unit 1450 may be disposed on the outside of the arm massage unit 1200.

The interface unit 1450 may include an input unit and/or an output unit. The input unit may receive a user input from the user and transmit the received user input to the control unit 1400. The output unit may display the information on the massage device 1000. For example, the output unit may output various information such as at least one of the processing results of the control unit 1400, information on the operation of at least one massage unit among the body massage unit 1100, the arm massage unit 1200 and the leg massage unit 1300, and the information on a massage mode that is performed.

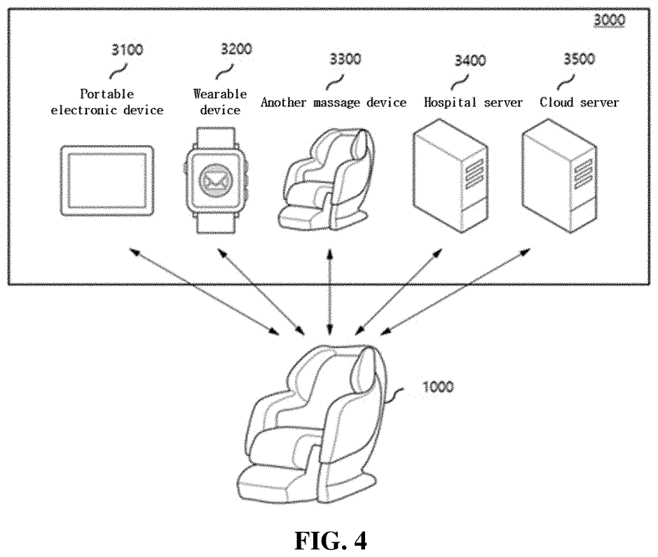

Specifically, the input unit may receive commands from the user, related to operation control of the massage device 1000 and the input unit may be implemented in various forms. For example, the input unit may be provided in the body massage unit 1100 or may be provided in the leg massage unit 1300, but the present disclosure is not limited thereto. In addition, the input unit may include the user input unit (not shown) or the massage device control device 2000 of FIG. 1, or various external devices which will be described in FIG. 4.

The massage device 1000 may acquire various commands from the user through the input unit. For example, the massage device 1000 may receive an arbitrary command for selection of a massage module, selection of a massage type, selection of a massage intensity, selection of a massage time period, selection of a part to be massaged, selection of a position and operation of the body massage unit 1100, selection of power-on/off of the massage device 1000, selection of whether to operate a heating function, or selection related to sound source playback, but the present disclosure is not limited thereto.

The massage device 1000 may provide an interface for selecting a massage mode through the interface unit 1450. For example, the input unit and/or the output unit may include the massage device control device 2000. Various medical massage modes related to body condition improvement may be listed through the massage device control device 2000.

The medical massage modes may include at least one of a concentration mode, a meditation mode, a recovery mode, a stretching mode, a sleeping mode, a vitality mode, a golf mode, a hip-up mode, an examinee mode, a weightless mode, and a growth mode.

According to another embodiment of the present disclosure, the interface unit 1450 may include buttons in the form of hot keys according to preset user-set functions, autonomously preset functions, or the like and/or selection buttons for performing direction selection, cancellation or input.

The interface unit 1450 may be implemented using a touch screen, a key pad, a dome switch, a touch pad (static pressure/static electricity), a jog wheel, a jog switch, or the like, but the present disclosure is not limited thereto. In addition, the interface unit 1450 may acquire a command through utterance of a user based on a voice recognition technology.

The output unit may include a display for displaying an operation state of the massage device 1000, a current state of a user, or the like. In this case, the display may include at least one of a liquid crystal display LCD, a thin film transistor liquid crystal display TFT LCD, organic light-emitting diodes OLEDs, a flexible display, and a three-dimensional display, but the present disclosure is not limited thereto.

The output unit may include the audio output unit 1440. The audio output unit 1440 of FIG. 3 may include the audio output module 1500 of FIG. 1. The audio output unit 1440 may provide any type of audio output to a user. For example, the audio output unit 1440 may provide brain stimulation to a user by outputting to a user a sound source and/or a binaural beat optimized to a massage pattern provided by the massage device 1000. The audio output unit 1440 may output a sound signal that is received through a network (not shown) or stored in an internal/external storage medium (not shown). For example, the audio output unit 1440 may output a sound source under control of a user terminal through a network connection (for example, Bluetooth connection) with the user terminal. In addition, the audio output unit 1440 may output any type of sound signal generated in relation to the operation of the massage device 1000.

It may be well understood by those skilled in the art that the present disclosure may be implemented in cooperation with other program modules and/or as a combination of hardware and software. For example, the present disclosure may be implemented by a computer-readable medium.

The computer-readable medium may be any medium that may be accessed by a computer, and the computer-readable medium includes a volatile or nonvolatile medium, a transitory or non-transitory medium, and a portable or non-portable medium. The computer-readable medium may include a computer-readable storage medium and a computer-readable transmission medium as a nonrestrictive example.

The computer-readable storage medium may include a volatile or nonvolatile medium, a transitory or non-transitory medium, and a portable and non-portable medium, which is implemented by an arbitrary method or technique of storing information such as a computer-readable command, a data structure, a program module, or other types of data. The computer-readable storage medium includes a RAM, a ROM, an EEPROM, a flash memory, or other memory technologies, a compact disc-ROM CD-ROM, a digital video disk DVD, or other optical disk storage devices, a magnetic cassette, magnetic tape, a magnetic disk storage device, or other magnetic storage devices, or any other media, which may be accessed by a computer and used for storing desired information, but the present disclosure is not limited thereto.

FIG. 4 is a view showing an external device capable of communicating with the massage device 1000 according to one embodiment of the present disclosure.

The massage device 1000 may communicate with an external device 3000 in a wired or wireless manner and may transmit/receive various types of data.

The external device 3000 may include an artificial intelligence AI speaker or a portable electronic device 3100 such as a tablet personnel computer or a smart-phone. The portable electronic device 3100 may be dedicated to the massage device 1000 or may be a general-purpose portable electronic device. In addition, the external device 3000 may include a wearable device 3200 such as a smart watch or a smart band. The external device 3000 may include a massage device 3300 rather than the massage device 1000 currently used for a user. The external device 3000 may include a hospital server 3400. The external device 3000 may include a personal health record PHR server. In addition, the external device 3000 may include a cloud server 3500. The external device 3000 may include a medical measurement device such as an electronic weighing machine, a blood glucose meter, or a blood pressure meter.

Although some examples of the external device 3000 have been described in the present disclosure, it should be understood that any device capable of communicating with the massage device 1000 in a wired or wireless manner and exchanging information with the massage device 1000 may be included in the external device.

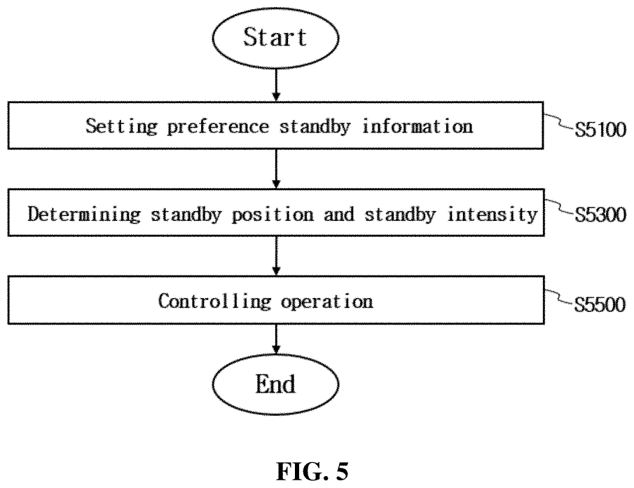

FIG. 5 shows an example for describing a control operation of a control unit according to one embodiment of the present disclosure.

The control unit 1400 may set user's preference standby information for the massage module 100 based on a user's input (S5100). In this case, the user's input may be received (or sensed or acquired) through at least one of external devices that communicate with the interface unit 1450 and the massage device 1000 as described above.

For example, preference standby information may be detailed information on the massage module 100 in a state in which the massage device 1000 is driven and a massage mode ends. The preference standby information may be set by a user and stored in the memory 1430.

The preference standby information may include information on a preference standby position and/or a preference standby intensity for the massage module 100, which is set by the user to have the massage module 100 on standby.

The preference standby position may be a position for standby of the massage module 100 in a state where the massage device 1000 is driven and a massage mode ends. For example, the preference standby information may be an area selected by the user from among entire areas of the main frame 1110. At this time, the entire areas may be a movement path along which the massage module 100 moves.

The preference standby intensity may be an intensity of the massage module 100 that stands by at the preference standby position in a state in which the massage device 1000 is driven and a massage mode ends. For example, the preference standby intensity may be an intensity selected by the user from among a plurality of intensities (or a plurality of massage intensities) of the massage module 100. In this case, the plurality of intensities may be determined based on a degree to which the massage module 100 advances or retreats in the forward and/or backward direction of the massage module 100. The intensity of the massage device may be stronger as the massage module 100 moves more in the forward direction of the massage module 100, and weaker as the massage module 100 moves more in the backward direction of the massage module 100.

The control unit 1400 may determine at least one of a standby position, at which the massage module 100 is on standby in the main frame 1110, and a standby intensity, which is an intensity at which the massage module 100 presses the body of a user at the standby position, based on at least one of whether a massage mode of the massage device 1000 has ended and the preference standby information (S5300). For example, the control unit 100 may determine at least one of a standby position and a standby intensity of the massage module 100 based on the preference standby information when a massage mode of the massage device 1000 ends.

The control unit 1400 may control the operation of the massage module 100 based on at least one of the standby position and the standby intensity (S5500).

As described above, when a massage mode ends, the control unit 1400 controls position and intensity of the massage module 100 according to the position and intensity preferred by a user, so that it is possible to provide a user-customized seating feeling to the user who wants to seat in the massage device 1000 even when a massage is not provided.

Therefore, the control unit 1400 may improve user's satisfaction with using the massage device by improving the seating satisfaction of a user who is seated in the massage device 1000 and the sleep satisfaction of a user who sleeps in the massage device 1000.

That is, the control unit 1400 may increase user's satisfaction with the massage device 1000 by reflecting the needs of the user seated in the massage device 1000 to the operation control of the massage device 1000.

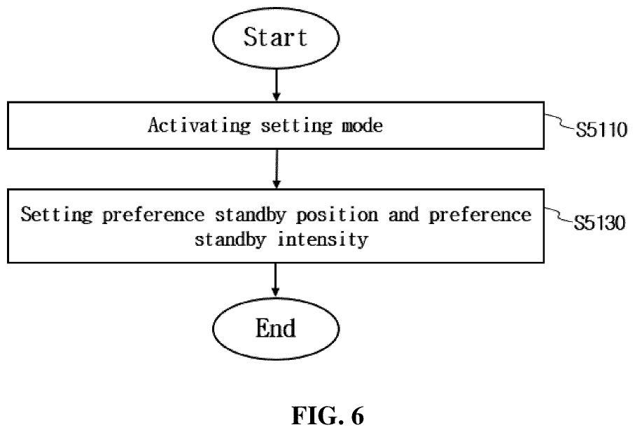

FIG. 6 is a view for describing the step of setting preference standby information shown in FIG. 5.

The control unit 1400 may set at least one of a preference standby position and a preference standby intensity (S5100).

For example, the control unit 1400 may activate a setting mode for setting preference standby information until a massage mode of the massage device 1000 is performed (S5110). For example, the control unit 1400 may activate the setting mode at at least one time point at which the massage device 1000 is driven or before performing a massage mode. The control unit 1400 may deactivate the setting mode while the massage mode is running.

The control unit 1400 may set at least one of a preference standby position and a preference standby intensity in the setting mode based on a user's input (S5130).

For example, the control unit 1400 may enter the setting mode based on a user's setting mode selection input.

The control unit 1400 may set at least one of a preference standby position and a preference standby intensity based on a user's additional input in a state where the setting mode is entered. In this case, an additional input may include at least one of a user's change input and a user's setting input. A change input may be an input for changing at least one of the position and intensity of the massage module 100, and a setting input may be an input for setting a preference standby position and a preference standby intensity.

Specifically, the control unit 1400 may change at least one of position and intensity of the massage module 100 in response to a user's change input. A change input may include a user's position change input and a user's intensity change input. A position change input may be an input for changing the position of the massage module 100, and the intensity change input may be an input for changing the intensity of the massage module 100.

When a position change input is received, the control unit 1400 may change the position of the massage module 100 by moving the massage module 100 in response to the user's position change input. For example, the control unit 1400 may move the massage module 100 in at least one of an upper direction and a lower direction of the massage module 100 (or move the massage module 100 up and/or down) in response to a position change input.

When a position change input is not received, the control unit 1400 may maintain the position of the massage module 100.

If an intensity change input is received, the control unit 1400 may change the intensity of the massage module 100 by adjusting the intensity of the massage module 100 in response to the intensity change input. For example, the control unit 1400 may adjust the intensity of the massage module 100 by moving the massage module 100 in at least one direction of the forward direction and the backward direction of the massage module 100 (or moving the massage module 100 forward and/or backward) in response to an intensity change input.

If an intensity change input is not received, the control unit 1400 may maintain the intensity of the massage module 100.

The control unit 1400 may set a preference standby position and a preference standby intensity in response to a setting input. For example, the control unit 1400 may determine a position of the massage module 100 at a time when a setting input is received as a preference standby position. The control unit 1400 may determine an intensity of the massage module 100 at a time when a setting input is received as a preference standby intensity.

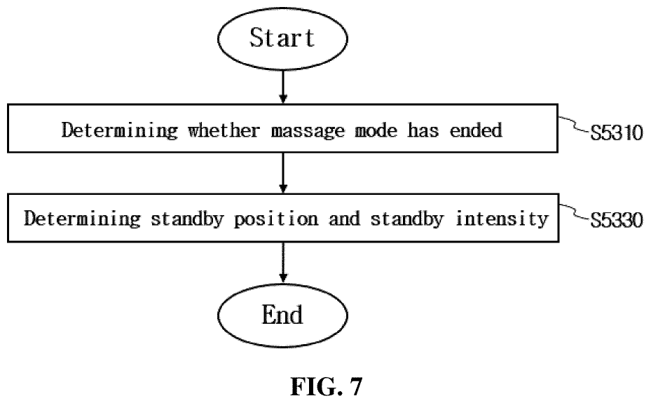

FIG. 7 is a view for describing the step of determining a standby position and a standby intensity shown in FIG. 5.

The control unit 1400 may determine at least one of a standby position and a standby intensity of the massage module 100 based on at least one of whether a massage mode has ended and preference standby information (S5300).

First, the control unit 1400 may determine whether the massage device 1000 has ended a massage mode (S5310).

For example, the control unit 1400 may control the operation of the massage device 1000 corresponding to a massage mode selected by a user by performing the massage mode selected by the user among a plurality of massage modes. At this time, the plurality of massage modes may be massage modes that the massage device 1000 may provide.

The control unit 1400 may monitor the operation of the massage device 1000 and determine whether the massage mode selected by the user has ended based on whether the massage device 1000 has performed operation corresponding to the massage mode selected by the user.

When the whole operation of the massage device 1000 corresponding to the massage mode selected by the user have been performed, the control unit 1400 may determine that the massage mode selected by the user has ended (or completed).

Subsequently, the control unit 1400 may determine at least one of a standby position and a standby intensity of the massage module 100 based on the determination result and preference standby information (S5330).

When the massage mode has ended, the control unit 1400 may determine a standby position as a preference standby position and a standby intensity as a preference standby intensity.

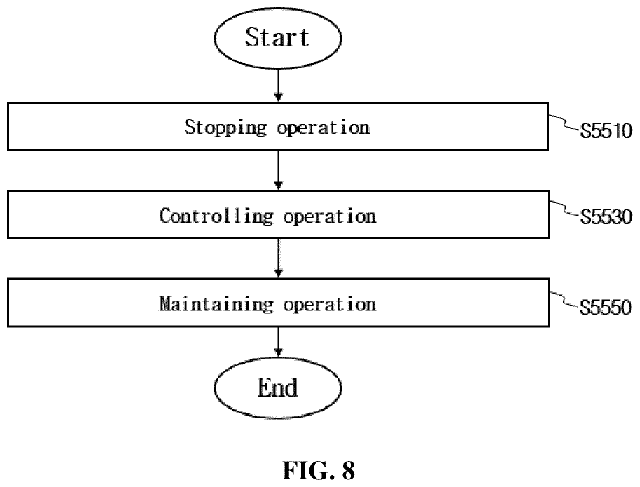

FIG. 8 is a view for describing the step of controlling a massage module shown in FIG. 5.

The control unit 1400 may control the operation of the massage module 100 based on at least one of the standby position and standby intensity of the massage module 100 (S5500).

When the massage mode has ended, the control unit 1400 may stop the operation of the massage device 1000 (S5510).

For example, the control unit 1400 may stop the operation of the detailed components included in the massage device 1000, such as the body massage unit 1100, the arm massage unit 1200, the leg massage unit 1300, the actuator of the massage device 1000, and the massage module 100. At this time, the angle of the stopped massage device 1000 may be the angle of the massage device 1000 corresponding to a time point when the massage mode has ended.

The control unit 1400 may control the operation of the massage module 100 based on the standby position and standby intensity of the massage module 100 (S5530).

For example, the control unit 1400 may control the position of the massage module 100 by moving the position of the massage module 100 to the standby position of the massage module 100. At this time, the position of the massage module 100 may be an area where the massage module 100 is positioned at a time when the massage device 1000 is stopped among all areas of the main frame 1110.

When the position of the massage module 100 is the same as the standby position, the control unit 1400 may maintain the position of the massage module 100.

When the position of the massage module 100 is lower than the standby position, the control unit 1400 may move the massage module 100 to the standby position by moving the massage module 100 upward in the upward direction of the massage module 100.

When the position of the massage module 100 is higher than the standby position, the control unit 1400 may move the massage module 100 to the standby position by moving the massage module 100 downward in the downward direction of the massage module 100.

The control unit 1400 may control the intensity of the massage module 100 by adjusting the intensity of the massage module 100 to the standby intensity of the massage module 100. Herein, the intensity of the massage module 100 may be the intensity of the massage module 100 corresponding to a time point when the massage device 1000 is stopped among a plurality of intensities.

When the intensity of the massage module 100 is the same as the standby intensity, the control unit 1400 may maintain the intensity of the massage module 100.

If the intensity of the massage module 100 is lower than the standby intensity, the control unit 1400 may adjust the intensity of the massage module 100 to the standby intensity by moving the massage module 100 in the forward direction of the massage module 100.

If the intensity of the massage module 100 is higher than the standby intensity, the control unit 1400 may adjust the intensity of the massage module 100 to the standby intensity by moving the massage module 100 to the backward direction of the massage module 100.

The control unit 1400 may maintain the operation of the massage module 100 and the stopped massage device 1000 (S5550). Step S5550 will be described in detail hereinafter.

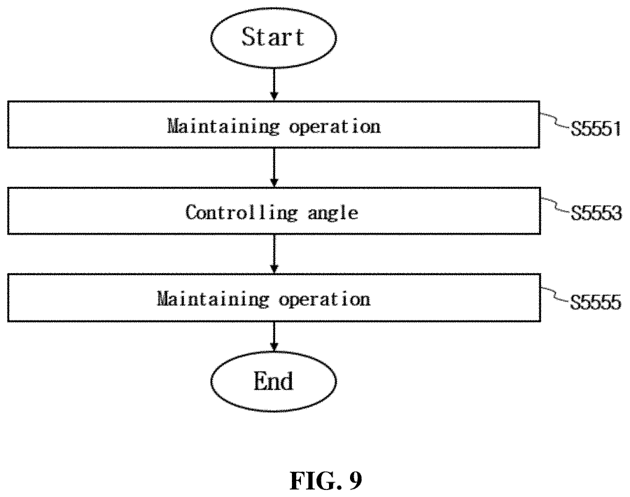

FIG. 9 is a view for describing the step of maintaining the operation of the massage module and the stopped massage device shown in FIG. 8.

The control unit 1400 may maintain the operation of the massage module 100 and the stopped massage device 1000 (S5550).

First, the control unit 1400 may maintain the operation of the massage module 100 (S5551). For example, the control unit 1400 may maintain the position and intensity of the massage module 100 after controlling the position and intensity of the massage module 100. The control unit 1400 may stop the operation of the massage module 100 and maintain the operation of the stopped massage module 100.

Subsequently, the control unit 1400 may control the angle of the stopped massage device 1000 based on whether a preset standby angle and the angle of the stopped massage device 1000 are the same (S5553). At this time, a standby angle may be preset by various objects and stored in the memory 1430. Such a standby angle may be an angle suitable for a user to wait in the massage device 1000 and may be an angle at which the massage device 1000 is maximally inclined in the backward direction of the massage device 1000, but is not limited thereto. The standby angle may be set to various angles, such as at least one of about 130 degrees, about 150 degrees, and about 170 degrees as a zero-gravity angle.

When the angle of the stopped massage device 1000 is different from a standby angle, the control unit 1400 may change the angle of the stopped massage device 1000 through the actuator described above. For example, the control unit 1400 tilts the stopped massage device 1000 in at least one direction of the forward and backward directions of the massage device 1000 based on the standby angle so that the angle of the stopped massage device 1000 may be changed to the standby angle.

When the angle of the stopped massage device 1000 is the same as the standby angle, the control unit 1400 may maintain the angle of the stopped massage device 1000.

The control unit 1400 changes the angle of the stopped massage device 1000 as described above when the angle of the stopped massage device 1000 is different from the standby angle, but the present disclosure is not limited thereto.

For example, the control unit 1400 may maintain the angle of the stopped massage device 1000 even when the angle of the stopped massage device 1000 is different from the standby angle.

The control unit 1400 may maintain the operation of the stopped massage device 1000 (S5555). For example, the control unit 1400 may maintain the operation of the detailed components of the stopped massage device 1000 in a stopped state.

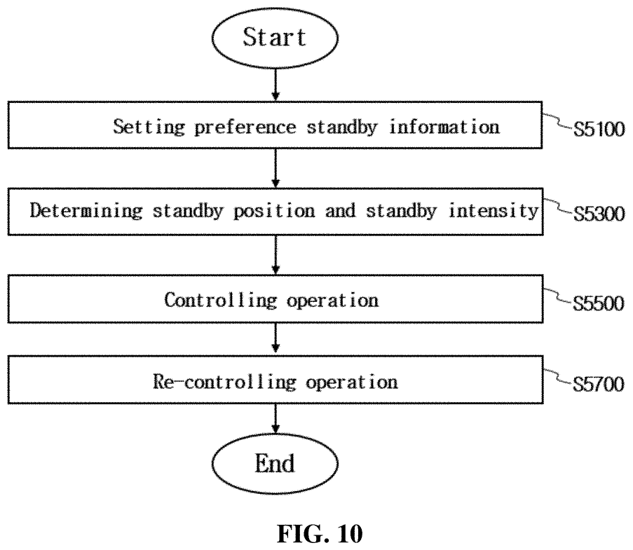

FIG. 10 shows another example for describing a control operation of a control unit according to one embodiment of the present disclosure.

The control unit 1400 may maintain the operation of the massage module 100 and the stopped massage device 1000 by performing steps S5100 to S5500, as shown in Fig. FIG. 5 to FIG. 9.

The control unit 1400 may re-control the operation of the massage module 100 and the stopped massage device 1000 based on whether a control signal for changing the operation of the massage device 1000 is generated (S5700), after maintaining the operation of the massage module 100 and the stopped massage device 1000.

When a control signal is not generated, the control unit 1400 may maintain the operation of the massage module 100 and the stopped massage device 1000.

When a control signal is generated, the control unit 1400 may change the operation of the massage module 100 and the stopped massage device 1000. The operation of changing the operation of the massage module 100 and the stopped massage device 1000 will be described in detail hereinafter.

A control signal may be at least one of an angle change signal for changing the angle of the massage device 1000 to a preset initial angle and an end signal for ending the operation of the massage device 1000. The control signal may be generated by a user's input received through at least one of the interface unit 1450 and an external device. The control signal may be generated by at least one of the interface unit 1450 and an external device based on a user's input and transmitted to the control unit 1400, or may be generated by the control unit 1400 based on a user's input received through at least one of them.

An initial angle may be preset by various objects and stored in the memory 1430. Such an initial angle may be an angle suitable for a user to seat in the massage device 1000 and may be an angle at which the massage device 1000 is maximally inclined in the forward direction of the massage device 1000, but is not limited thereto. For example, the initial angle may be set to various angles, such as at least one of about 90 degrees, about 100 degrees, and about 110 degrees. The initial angle and the standby angle are different from each other as described above, and the initial angle may be an angle smaller than the standby angle.

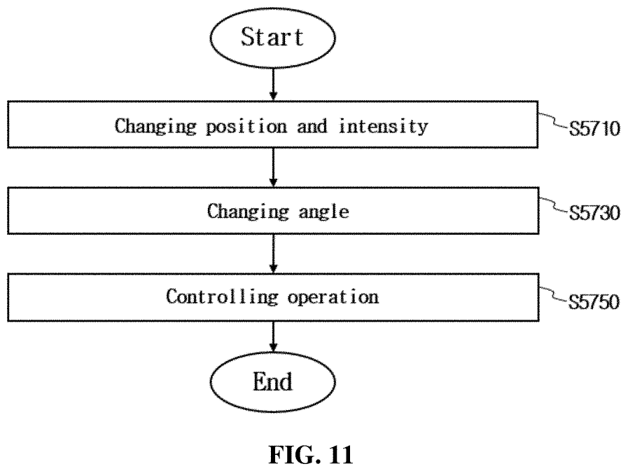

FIG. 11 is a view for describing the step of re-controlling the operation of the massage module and the stopped massage device shown in FIG. 10.

When a control signal is generated, the control unit 1400 may change the operation of the massage module 100 and the stopped massage device 1000 so as to re-control the operation of the operation of the massage module 100 and the stopped massage device 1000 (S5700).

First, the control unit 1400 may change the position and intensity of the massage module 100 based on preset initial standby information (S5710).

For example, initial standby information may be detailed information on the massage module 100 in a state in which the operation of the massage device 1000 has ended (or the massage device 1000 is not driven). The Initial standby information may be preset by various objects and stored in the memory 1430.

The initial standby information may include information on at least one of an initial standby position and an initial standby intensity for the massage module 100, which is preset to allow the massage module 100 to wait.

The initial standby position may be a position for standby of the massage module 100 in a state in which the operation of the massage device 1000 has ended. For example, the initial standby position may be any one preset area among the entire areas of the main frame 1110. Specifically, the initial standby position may be an area positioned at an uppermost end of the entire areas of the main frame 1110, but is not limited thereto. For example, the initial standby position may be set to various areas, such as at least one of an area positioned at a lowermost end and an area positioned in the middle of the entire areas of the main frame 1110.

The initial standby intensity may be an intensity of the massage module 100 waiting at the initial standby position in a state in which the operation of the massage device 1000 has ended. For example, the initial standby intensity may include information on at least one of initial standby intensities, which is any one preset intensity among a plurality of intensities. Specifically, the initial standby intensity may be a weakest intensity among the plurality of intensities, but is not limited thereto. For example, the initial standby intensity may be set to various intensities, such as at least one of a strongest intensity and a middle intensity among the plurality of intensities.

The control unit 1400 may change the position of the massage module 100 based on an initial standby position. For example, the control unit 1400 may change the position of the massage module 100 by moving the position of the massage module 100 from a preference standby position to an initial standby position.

The control unit 1400 may change the intensity of the massage module 100 based on a preset initial standby intensity. For example, the control unit 1400 may change the intensity of the massage module 100 by changing the intensity of the massage module 100 from a preference standby intensity to an initial standby intensity.

After that, the control unit 1400 may change the angle of the stopped massage device 1000 based on an initial angle (S5730). For example, the control unit 1400 may change the angle of the stopped massage device 1000 by tilting the stopped massage device 1000 in at least one direction of the forward direction and the rearward direction of the massage device 1000 based on an initial angle.

Finally, the control unit 1400 may control the operation of the changed massage module 100 and the changed massage device 1000 based on whether a control signal is an end signal (S5750).

When the control signal is an angle change signal, the control unit 1400 can maintain the operation of the changed massage module 100 and the changed massage device 1000.

When the control signal is an end signal, the control unit 1400 may end the operation of the changed massage device 1000.

As described above, when a massage mode ends and a control signal does not occur, the control unit 1400 can move the position of the massage module 100 to a preference standby position, adjust the intensity of the massage module 100 to a preference standby intensity, and then maintain the operation of the massage module 100 and the operation of the massage device 1000.

As described above, when a massage mode ends and a control signal occurs, the control unit 1400 can move the position of the massage module 100 to an initial standby position, adjust the intensity of the massage module 100 to an initial standby intensity, and then end or maintain the operation of the massage module 100 and the operation of the massage device 1000.

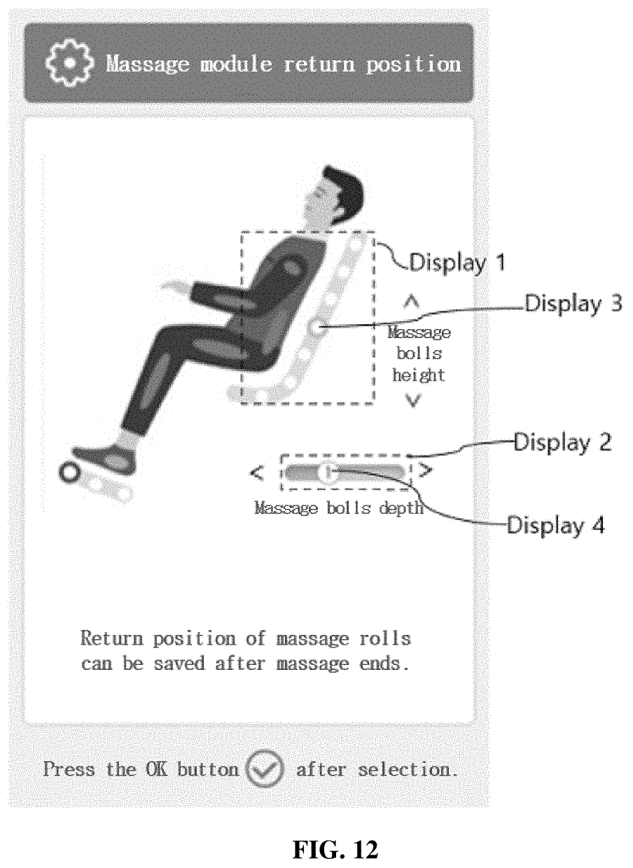

FIG. 12 is a view for describing a preference position and a preference intensity according to one embodiment of the present disclosure.

The control unit 1400 can visualize a preference standby position and a preference standby intensity through the interface unit 1450 and at least one of external devices.

For example, the control unit 1400 may visualize the entire areas of the main frame 1110 and the plurality of intensities of the massage module 100 through the interface unit 1450 and the display of at least one of external devices. At this time, the entire areas may be visualized by a first display, which indicates the position of each area, and the plurality of intensities may be visualized by a second display, which indicates the intensity level of each intensity as a number.

The control unit 1400 can visualize a preference standby position, which is an area selected by a user among the entire areas of the main frame 1110, and a preference standby intensity, which is an intensity selected by the user among the plurality of intensities. At this time, the preference standby position may be visualized by a third display, which indicates an area corresponding to the massage module 100 among the entire areas, and the preference standby intensity may be visualized by a fourth display, which indicates the intensity selected by the user among the plurality of intensities.

For example, the control unit 1400 may visualize the preference standby position and the preference standby intensity by illuminating the third and fourth displays. The preference standby position may be illuminated in such a way that a boundary line of a shape corresponding to the preference standby position lights or flickers. The preference standby intensity can be visualized as a number representing the intensity. The preference standby intensity may be illuminated in such a way that the inside of a shape corresponding to the preference standby intensity lights or flickers.

Although the technical idea of the present disclosure has been described above with reference to the accompanying drawings, this is intended to exemplarily describe preferred embodiments of the present disclosure but does not limit the present disclosure. In addition, it would be apparent to those skilled in the art to which the present disclosure belongs that various modifications and imitations may be implemented without departing from the technical spirit of the present disclosure.

Furthermore, the components and functions of the massage device of the present specification can be extended and applied to various (wearable) healthcare devices capable of providing healthcare functions (for example, massage functions, bio signal measurement functions, etc.). Accordingly, it is of course possible to replace the “massage device” in the present specification with a “(wearable) healthcare device”.

1. A method for controlling a massage module of a massage device, comprising the steps of:
determining at least one of a standby position at which a massage module is on standby in a main frame of a massage device, and a standby intensity, which is an intensity at which the massage module presses body of a user at the standby position, based on at least one of whether a massage mode of the massage device has ended and preference standby information on the massage module; and
controlling operation of the massage module based on at least one of the standby position and the standby intensity,
wherein the main frame supports the body of the user and the massage module provides a massage to at least a part of the body while moving along the main frame.

2. The method according to claim 1, wherein the determining step includes the steps of:
determining whether the massage mode has ended; and
determining the standby position and the standby intensity based on the determination result and the preference standby information,
wherein the preference standby information includes information on at least one of preference standby position and preference standby intensity for the massage module, which is set by the user to have the massage module on standby, the preference standby position is an area selected by the user from among entire areas of the main frame, and the preference standby intensity is an intensity selected by the user from among a plurality of intensities of the massage module.

3. The method according to claim 2, wherein the step of determining the standby position and the standby intensity includes the steps of, when the massage mode of the massage device has ended, determining the standby position as the preference standby position, and determining the standby intensity as the preference standby intensity.

4. The method according to claim 3, wherein the controlling step includes the steps of, when the massage mode has ended, stopping operation of the massage device, controlling operation of the massage module based on the standby position and the standby intensity, and maintaining the operation of the massage module and the stopped massage device.

5. The method according to claim 4, wherein
the step of controlling operation of the massage module based on the standby position and the standby intensity includes the steps of:
moving position of the massage module to the standby position; and
adjusting intensity of the massage module to the standby intensity.

6. The method according to claim 5, wherein
the maintaining step includes the steps of:
maintaining the operation of the massage module;
controlling angle of the stopped massage device based on whether a preset standby angle and the angle of the stopped massage device are the same; and
maintaining the operation of the stopped massage device.

7. The method according to claim 6, wherein
the step of controlling angle of the stopped massage device includes the steps of:
when the angle of the stopped massage device is different from the standby angle, changing the angle of the stopped massage device; and
when the angle of the stopped massage device is the same as the standby angle, maintaining the angle of the stopped massage device,
wherein the step of changing the angle of the stopped massage device includes the step of tilting the stopped massage device in at least one direction of a forward direction and a backward direction of the massage device based on the standby angle.

8. The method according to claim 4, further comprising the step of re-controlling the operation of the massage module and the stopped massage device based on whether a control signal for changing the operation of the massage device is generated, after maintaining the operation of the massage module and the stopped massage device,
wherein the control signal is at least one of an angle change signal for changing the angle of the massage device to a preset initial angle and an end signal for ending the operation of the massage device.

9. The method according to claim 8, wherein
the re-controlling step includes the steps of:
maintaining the operation of the massage module and the stopped massage device, when the control signal is not generated; and
changing the operation of the massage module and the stopped massage device 1000, when the control signal is generated.

10. The method according to claim 9, wherein
the changing step includes the steps of:
changing position and intensity of the massage module based on preset initial standby information;
changing angle of the stopped massage device based on the initial angle; and
controlling operation of the changed massage module and the changed massage device based on whether the control signal is the end signal,
wherein the initial standby information includes information on at least one of an initial standby position and an initial standby intensity for the massage module, which is preset to allow the massage module to wait,
the initial standby position is any one preset area among the entire areas, and the initial standby intensity is any one preset intensity among the plurality of intensities.

11. The method according to claim 10, wherein
the step of changing position and intensity of the massage module includes the steps of:
changing position of the massage module by moving the position of the massage module from the preference standby position to the initial standby position; and
changing intensity of the massage module by adjusting the intensity of the massage module from the preference standby intensity to the initial standby intensity.

12. The method according to claim 10, wherein the step of changing angle of the stopped massage device includes the step of changing angle of the stopped massage device by tilting the stopped massage device in at least one direction of the forward direction and the rearward direction of the massage device based on the initial angle.

13. The method according to claim 10, wherein
the step of controlling operation of the changed massage module and the changed massage device includes the steps of:
maintaining operation of the changed massage module and the changed massage device when the control signal is the angle change signal; and
ending operation of the changed massage device when the control signal is the end signal.

14. The method according to claim 3, further comprising the step of activating a setting mode for setting the preference standby information so as to set the preference standby information, before the massage mode is performed.

15. A massage device, comprising:
a main frame for supporting body of a user;
a massage module for providing a massage to at least a part of the body while moving along the main frame; and
a control unit for controlling the massage module,
wherein the control unit determines at least one of a standby position, at which the massage module is on standby in the main frame of the massage device, based on whether a massage mode of the massage device has ended, and a standby intensity, which is an intensity at which the massage module presses the body at the standby position, and the control unit controls operation of the massage module based on at least one of the standby position and the standby intensity.
